SEQUENCE LISTING (4 sequences)

SEQ ID NO: 1 - DNA, 15 bp, Artificial Sequence
  Arbitrary sequence for illustrative purposes
gatgaggcatttgac

SEQ ID NO: 2 - DNA, 15 bp, Artificial Sequence
  Arbitrary sequence for illustrative purposes
ctactccgtaaactg

SEQ ID NO: 3 - DNA, 15 bp, Artificial Sequence
  Arbitrary sequence for illustrative purposes
gatgaggcgtttgac

SEQ ID NO: 4 - DNA, 15 bp, Artificial Sequence
  Arbitrary sequence for illustrative purposes
ctactccgcaaactg

(19) United States
(12) Patent Application Publication
(10) Pub. No.: US 2004/0178070 A1
(43) Pub. Date: Sep. 16, 2004

(54) Method and system for comparative genomics for organisms using temperature gradient electrophoresis

(76) Inventor: Zhaowei Liu, State College, PA (US)

Correspondence Address: FISH & RICHARDSON P.C., 1425 K STREET, N.W., 11TH FLOOR, WASHINGTON, DC, 20005-3500, US

(21) Appl. No.: 10/619,588

(22) Filed: Jul. 16, 2003

Related U.S. Application Data
(63) Continuation of application No. 10/287,826, filed on Nov. 5, 2002.
(60) Provisional application No. 60/396,006, filed on Jul. 16, 2002.

(51) Int. Cl. G01N 27/453

(52) U.S. Cl. 204/450; 204/600

(57) ABSTRACT

A first aspect of the invention relates to a method of determining whether a sequence of a first portion of a polynucleotide of a first organism and a sequence of a first portion of a polynucleotide of a second organism comprise a mismatch. The method may comprise preparing a plurality of duplexes, which may comprise either or both of (i) a first polynucleotide strand having a sequence corresponding to a sequence of a first portion of genomic DNA of a first organism and (ii) a first complementary polynucleotide strand having a sequence corresponding to a sequence of a first portion of genomic DNA of a second organism.

The duplexes may be subjected to temperature gradient electrophoresis (TGE) to obtain first electrophoresis data indicative of the presence of a mismatch between (a) the sequence of the first portion of the genomic DNA of the first organism and (b) the sequence of the complementary portion of the genomic DNA of the second organism.

### RELATED APPLICATIONS

The present application claims priority to U.S. Application No. Unassigned, filed Jul. 14, 2003 under attorney client docket number 9046-059-999, naming Zhaowei LIU, Zhiyong GUO, Christina MAYE, and Kevin R. GUTSHALL, as inventors, which application itself claims priority to U.S. Provisional Application No. 60/395,614, filed Jul. 15, 2002. The present application also claims priority to U.S. Provisional Application No. 60/396,006, filed Jul. 16, 2002. The present application is also a continuation of U.S. application Ser. No. 10/287,826, filed Nov. 5, 2002, which claims priority to international application no. PCT/US01/274401, filed Sep. 4, 2001, which claims priority to U.S. Provisional Application No. 60/229,302, filed Sep. 1, 2000. Each of the foregoing applications is incorporated by reference in its entirety.

### FIELD OF THE INVENTION

The present invention relates to a system and method for comparative genomics. In particular, the invention may provide a method for comparing genomic DNA of related organisms using temperature gradient electrophoresis.

### BACKGROUND

Comparative genomics is usually based on comparing the whole genome sequence of various organisms. Comparative genomics provides a powerful tool for illustrating chromosome structures, for annotating genes and for dissecting regulatory elements for gene expression. Comparative genome sequencing (CGS) is particularly useful for revealing the genetic variation among closely related organisms (i.e. among races, strains and individuals) since the existing technologies hardly resolve the differences of organisms with very little variability. However, the variability may be the important characteristics of these organisms, as seen in many cases. For instance, the variability may render a strain of a bacterium virulent to human, while another strain of the bacterium beneficial. Normally, CGS is performed by comparison of a reference genome sequence (already sequenced) with that of the testing genomes.

However, known CGS is a time-consuming and costly method. The testing genomes with tens of million base pairs have to be sequenced up to ten times, in order to identify variation at a few positions. The purpose of repeated determination is to eliminate the error introduced during the sequencing process. For example, researchers at the Institute for Genomic Research (TIGR) (T. D., S. L. Salzberg, M. Pop, M. Shumway, L. Umayam, L. Jiang, E. Holtzapple, J. D. Busch, K. L. Smith, J. M. Schupp, D. Solomon, P. Keim and C. M. Fraser Comparative Genome Sequencing for Discovery of Novel Polymorphisms in Bacillus anthracis Science 296:2028, 2002) had to sequence two testing anthrax strains each with eight times to find four sites of differences in a genome with 5.2 mbp. A shortcoming of the method used is that the vast majority of the identical nucleotide sequences have to be repeatedly determined. Thus, known methods inefficiently utilize resources.

### SUMMARY OF THE INVENTION

A first aspect of the invention relates to a method of determining whether a sequence of a first portion of a polynucleotide of a first organism and a sequence of a first portion of a polynucleotide of a second organism comprise a mismatch. The method may comprise preparing a plurality of duplexes, which may comprise either or both of (i) a first polynucleotide strand having a sequence corresponding to a sequence of a first portion of genomic DNA of a first organism and (ii) a first complementary polynucleotide strand having a sequence corresponding to a sequence of a first portion of genomic DNA of a second organism.

The duplexes may be subjected to temperature gradient electrophoresis (TGE) to obtain first electrophoresis data indicative of the presence of a mismatch between (a) the sequence of the first portion of the genomic DNA of the first organism and (b) the sequence of the complementary portion of the genomic DNA of the second organism.

A plurality of different duplexes may be prepared. The duplexes may comprise either or both of (i) a first polynucleotide strand having a sequence corresponding to a sequence of one of a plurality of different portions of the genomic DNA of the first organism and (ii) a first complementary polynucleotide strand having a sequence corresponding to a sequence of one of a plurality of different portions the genomic DNA of the second organism. The plurality of different duplexes may be subjected to temperature gradient electrophoresis. For any or all of the different duplexes first electrophoresis data may be obtained. The first electrophoresis data is preferably indicative of the presence of a mismatch between (a) the sequence of the first portion of the genomic DNA of the first organism and (b) the sequence of the complementary portion of the genomic DNA of the second organism.

Another embodiment of the invention relates to a method of determining whether a sequence of a first portion of a polynucleotide of a first organism and a sequence of a first portion of a polynucleotide of a second organism comprise a difference. The method may comprise amplifying at least a first portion of a polynucleotide of a first organism to prepare amplicons of the first organism. The amplicons of the first organism may correspond to a sequence of the polynucleotide of the first portion of the first organism. At least a first portion of a polynucleotide of a second organism may be amplified. Amplicons of the second organism may be obtained from the amplification. The amplicons of the second organism may correspond to a sequence of the polynucleotide of the first portion of the second organism.

A plurality of duplexes may be prepared. At least some of the duplexes may comprise amplicons of the first organism and amplicons of the second organism. The duplexes may be subjected to temperature gradient electrophoresis to obtain first electrophoresis data indicative of the presence of a difference between (a) a sequence of the first portion of the polynucleotide of the first organism and (b) a sequence of the first portion of the polynucleotide of the second organism.

The presence of a difference between the sequence of the first portion of the polynucleotide of the first organism and the sequence of the first portion of the polynucleotide of the second organism may be determined using the electrophoresis data. The sequence of the first amplicon of the second organism may be known and the method may comprise determining a sequence of the first portion of the polynucleotide of the first organism based on the electrophoresis data and the known sequence of the first amplicon of the second organism.

The first organism may be a first mammal, such as a human. The second organism may be a second, optionally different mammal, such as a second different human. The polynucleotide of either or both of the first and second organisms may comprise genomic DNA of the respective organisms.

Either or both of the first amplicons of the first organism and the first amplicons of the second organism may be prepared using a PCR reaction. concomitantly. The first amplicons of the first organism and the first amplicons of the second organism may be prepared using concomitantly. The first amplicons of the first organism and the first amplicons of the second organism may be prepared by a multiplexed amplification reaction.

The method may comprise amplifying at least a second portion of the polynucleotide of the first organism to prepare second amplicons of the first organism. The second amplicons of the first organism may correspond to a sequence of the second portion of the polynucleotide of the first organism. At least a second portion of the polynucleotide of the second organism may be amplified. Second amplicons of the second organism may be obtained from the amplification. The second amplicons of the second organism may correspond to a sequence of the second portion of the polynucleotide of the second organism.

A plurality of second duplexes may be prepared. At least some of the duplexes may comprise second amplicons of the first organism and second amplicons of the second organism. The second duplexes may be subjected to temperature gradient electrophoresis. First first electrophoresis data indicative of the presence of a difference between (a) a sequence of the second portion of the polynucleotide of the first organism and (b) a sequence of the second portion of the polynucleotide of the second organism may be obtained.

Another embodiment of the invention relates to a method of determining whether a sequence of a first portion of a polynucleotide of a first organism and a sequence of a first portion of a polynucleotide of a second organism comprise a difference. The method may comprise amplifying at least a first portion of a polynucleotide of a first organism to prepare first amplicons of the first organism. At least a first portion of a polynucleotide of a second organism may be amplified to prepare first amplicons of the second organism. At least one or both the first amplicons of the first organism and the first amplicons of the second organism may be denatured. A mixture comprising denatured first amplicons of the first and second organisms may be subjected to an annealing step.

Respective first amplicons of the first and second organisms may be subjected to temperature gradient electrophoresis to obtain first electrophoresis data indicative of the presence of a difference between (a) a sequence of the first portion of the polynucleotide of the first organism and (b) a sequence of the first portion of the polynucleotide of the second organism. The presence of a difference between the sequence of the first portion of the polynucleotide of the first organism and the sequence of the first portion of the polynucleotide of the second organism may be determined based on the electrophoresis data. The sequence of the first amplicon of the second organism may be known. The method may comprise determining a sequence of the first portion of the polynucleotide of the first organism based on the electrophoresis data and the known sequence of the first amplicon of the second organism.

The first organism may be a first mammal, such as a human. The second organism may be a second, optionally different mammal, such as a second different human. The polynucleotide of either or both of the first and second organisms may comprise genomic DNA of the respective organisms.

Either or both of the first amplicons of the first organism and the first amplicons of the second organism may be prepared using a PCR reaction. concomitantly. The first amplicons of the first organism and the first amplicons of the second organism may be prepared using concomitantly. The first amplicons of the first organism and the first amplicons of the second organism may be prepared by a multiplexed amplification reaction.

The method may further comprise amplifying, such as by a PCR reaction, at least a second portion of the polynucleotide of the first organism to prepare second amplicons of the first organism. At least a second portion of the polynucleotide of the second organism may be amplified, such as by a PCR reaction, to prepare second amplicons of the second organism. Either or both the second amplicons of the first organism and the second amplicons of the second organism may be denatured. A mixture comprising the respective denatured second amplicons of the first and second organisms may be subjected to an annealing step.

The mixture comprising the respective denatured first amplicons of the first and second organisms and the mixture comprising the respective denatured second amplicons of the first and second organisms may be the same mixture.

The step of subjecting the respective first amplicons of the first and second organisms to temperature gradient electrophoresis may comprise subjecting the respective second amplicons of the first and second organisms to temperature gradient electrophoresis to obtain second electrophoresis data indicative of the presence of a difference between a sequence of the second portion of the polynucleotide of the first organism and a sequence of the second portion of the polynucleotide of the second organism.

The method may comprise determining the presence of a difference between the sequence of the second portion of the polynucleotide of the first organism and the sequence of the second portion of the polynucleotide of the second organism based on the electrophoresis data. The first and second amplicons of the first and second organisms may be prepared concomitantly. The first and second amplicons of the first and second organisms may be prepared by a multiplexed amplification reaction.

The method may comprise jointly subjecting the first and second amplicons of the first and second organisms to temperature gradient electrophoresis along a common electrophoresis lane.

33. The method of claim 32, wherein the first amplicons of the first and second organisms and the second amplicons of the first and second organisms exhibit different electrophoretic migration velocities, the electrophoretic migration velocities of the first and second amplicons differing by an amount sufficient to determine the presence of one of the first and second amplicons in the presence of the other of the first and second amplicons even in the absence of (a) a difference between the sequence of the first portion of the polynucleotide of the first organism and the sequence of the first portion of the polynucleotide of the second organism and (b) a difference between the sequence of the second portion of the polynucleotide of the second organism and the sequence of the second portion of the polynucleotide of the second organism. The first and second amplicons may each comprise a length of at least 50 bp, for example at least 100 bp, or at least 150 bp. The first and second amplicons may have different lengths.

As in any embodiment of the invention, the electrophoresis lane may be a capillary.

The method may further comprise amplifying at least a third portion of the polynucleotide of the first organism to prepare third amplicons of the first organism. At least a third portion of the polynucleotide of the second organism may be amplified to prepare third amplicons of the second organism. The third amplicons of the first organism and the third amplicons of the second organism may be denatured. A mixture comprising the respective denatured third amplicons of the first and second organisms may be subjected to annealing.

The mixture comprising the respective denatured first amplicons of the first and second organisms, the mixture comprising the respective denatured second amplicons of the first and second organisms are the same mixture, and the mixture comprising the respective denatured third amplicons of the first and second organisms may be the same mixture.

The first, second, and third amplicons of the first and second organisms may be prepared concomitantly, such as by a multiplexed amplification reaction.

The step of subjecting the respective first amplicons of the first and second organisms to temperature gradient electrophoresis may comprise subjecting the second and third amplicons of the first and second organisms to temperature gradient electrophoresis to obtain (a) second electrophoresis data indicative of the presence of a difference between a sequence of the second portion of the polynucleotide of the first organism and a sequence of the second portion of the polynucleotide of the second organism and (b) third electrophoresis data indicative of the presence of a difference between a sequence of the third portion of the polynucleotide of the first organism and a sequence of the third portion of the polynucleotide of the second organism. The step of subjecting may comprise jointly subjecting the first, second, and third amplicons to temperature gradient electrophoresis along a common electrophoresis lane.

The method may comprise determining the presence of a difference between a sequence of the first portion of the polynucleotide of the first organism and a sequence of the first portion of the polynucleotide of the second organism based on the electrophoresis data.

The step of subjecting the respective first amplicons of the first and second organisms to temperature gradient electrophoresis may comprise (a) amplicon injection, wherein at least the first amplicons are introduced to a separation lane, and (b) electrophoresis, wherein at least the first amplicons migrate along the separation lane. The step of subjecting a mixture comprising the respective denatured first amplicons of the first and second organisms to annealing may be performed prior to electrophoresis.

Another embodiment of the invention relates to method of determining a sequence of a portion of a polynucleotide of a first organism. The method may comprise amplifying: (a) a plurality of sub-portions of a polynucleotide of a first organism to prepare amplicons corresponding to the sub-portions of the polynucleotide of the first organism and (b) a plurality of sub-portions of a polynucleotide of a second organism to prepare amplicons corresponding to the sub-portions of the polynucleotide of the second organism. At least some or all of the sub-portions of the second organism may have a known sequence. A plurality of duplexes may be prepared. The duplexes may comprise an amplicon of the first organism and an at least partially complementary amplicon of the second organism. The duplexes may be subjected to temperature gradient electrophoresis. Electrophoresis data indicative of the presence of a mismatch between the amplicon of the first organism and the at least partially complementary amplicon of the second organism may be obtained from the temperature gradient electrophoresis. Duplexes having a mismatch may be identified. For duplexes determined to have a mismatch, the identity of the mismatch between the amplicon of the first organism and the at least partially complementary amplicon of the second organism may be determined based on the known sequences of the corresponding sub-portion of the second organism. The sequence of at least a portion of the polynucleotide of the first organism may be determined based on (a) the known sequences of sub-portions of the second organism determined from the electrophoresis data not to have a mismatch with sub-portions of the first organism and (b) the identity of mismatches between amplicons of the first and second organisms.

Another embodiment of the invention relates to a method of determining whether a sequence of a first portion of a polynucleotide of a first organism and a sequence of a first portion of a polynucleotide of a second organism comprise a difference. The method may comprise either or both of (i) amplifying at least a first portion of a polynucleotide of a first organism to prepare first amplicons of the first organism and (ii) amplifying at least a first portion of a polynucleotide of a second organism to prepare first amplicons of the second organism. The first amplicons of the first organism and the first amplicons of the second organism may be denatured. A mixture comprising the respective denatured first amplicons of the first and second organisms may be subjected to an annealing step.

Respective first amplicons of the first and second organisms may be subjected to temperature gradient electrophoresis (TGE). First electrophoresis data indicative of the presence of a difference between (a) a sequence of the first portion of the polynucleotide of the first organism and (b) a sequence of the first portion of the polynucleotide of the second organism may be obtained from the TGE.

Another embodiment of the invention relates to a method of determining whether a sequence of a first portion of a polynucleotide of a first organism and a sequence of a first portion of a polynucleotide of a second organism comprise a difference. The method may comprise combining a polynucleotide of a first organism and a polynucleotide of a second organism. The polynucleotide of the first organism may comprise a first portion and the polynucleotide of the second organism may comprise a first portion

At least the first portion of the polynucleotide of the first organism and the first portion of the polynucleotide of the second organism may be ampified, such as to prepare amplicons comprising the amplified first portions.

The first amplicons may be denatured and, preferably subsequently, annealed. The first amplicons may be subjected to temperature gradient electrophoresis to obtain first electrophoresis data indicative of the presence of a difference between a sequence of the first portion of the polynucleotide of the first organism and a sequence of the first portion of the polynucleotide of the second organism.

The first organism may be a first mammal, such as a human. The second organism may be a second, optionally different mammal, such as a second different human. The polynucleotide of either or both of the first and second organisms may comprise genomic DNA of the respective organisms.

Either or both of the first amplicons of the first organism and the first amplicons of the second organism may be prepared using a PCR reaction. concomitantly. The first amplicons of the first organism and the first amplicons of the second organism may be prepared using concomitantly. The first amplicons of the first organism and the first amplicons of the second organism may be prepared by a multiplexed amplification reaction.

Another embodiment of the invention relates to a method of determining a sequence of at least a portion of a genome of a first organism. The method may comprise providing reference DNA obtained from a genome of a reference organism, and providing PCR primers suitable for amplifying the reference DNA, using the PCR primers to amplify the reference DNA in the presence of the portion of the genome of the first organism to thereby obtain amplicons.

The amplicons may be subjected to temperature gradient electrophoresis (TGE) to obtain electrophoresis data. At least one amplicon indicative of a variance between the reference DNA and the portion of the genome of the first organism may be identified based on the electrophoresis data. The at least one amplicon indicative of a variance may be sequenced to determine the sequence of the portion of the genome of the first organism.

### BRIEF DESCRIPTION OF THE FIGURES

The present invention is discussed below in reference to the Figures in which:

FIG. 1 illustrates preparation of homoduplexes and heteroduplexes.

FIG. 2 illustrates temperature gradient electrophoresis of homoduplexes and heteroduplexes along a separation lane.

FIG. 3 is a flowchart of exemplary steps in accordance with the present invention.

FIG. 4 illustrates how reference and sample strains may be combined as a template for PCR amplification, and how a SNP site may be included.

FIG. 5 illustrates preparation of homoduplexes and heteroduplexes at the nucleotide sequence level.

FIG. 6 illustrates that amplicons determined to comprise a difference between reference and sample sequences may be sequenced.

FIG. 7 illustrates pooling samples in accordance with the present invention.

### DETAILED DESCRIPTION OF THE PRESENT INVENTION

One aspect of the present invention relates to a method for comparing a test genome to a reference genome. The method may be used to rapidly identify sites of a test organism that vary with respect to sites of a reference genome. Preferably, the method comprises subjecting polynucleotides to temperature gradient electrophoresis (TGE). The present invention minimizes or eliminates need for generating genomic libraries, cloning, and colonies, all of which constitute lengthy presequencing steps that are major limitations in current genomic-scale sequencing protocols. The present invention does not require complicated sequence assembling procedures, as does the sequencing approach.

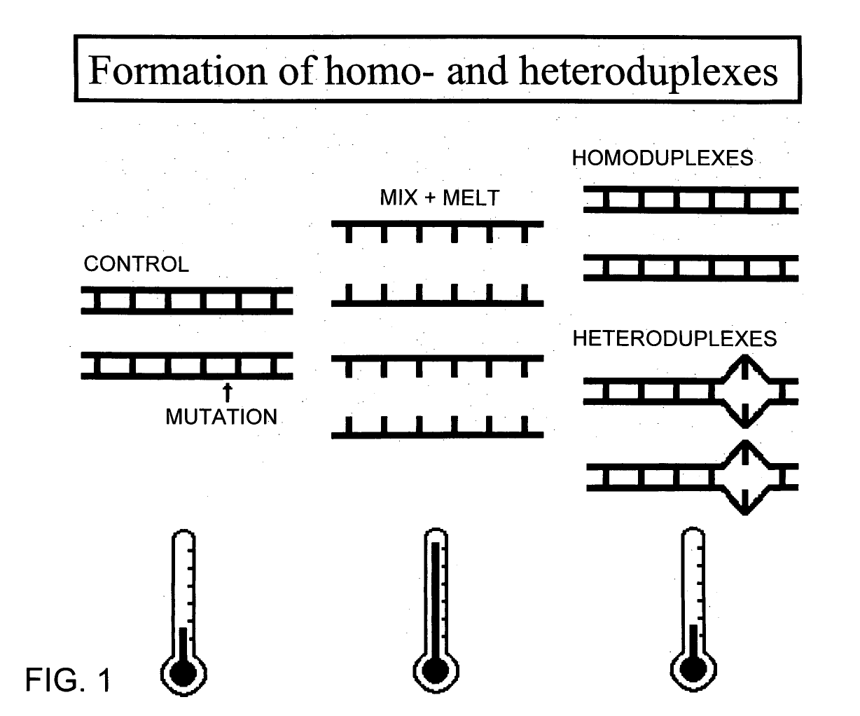

The TGE method of the invention may comprise heteroduplex analysis in which a heterozygous sample with a mutation/SNP is denatured and annealed to form two homoduplexes of original strands of DNA and two heteroduplexes each comprising a mismatch at the mutation/SNP site. These four species of DNA molecules may have different melting temperatures (Tm), which are the temperatures at which half of the double-stranded DNA molecules dissociates from each other and become single-stranded (FIG. 1).

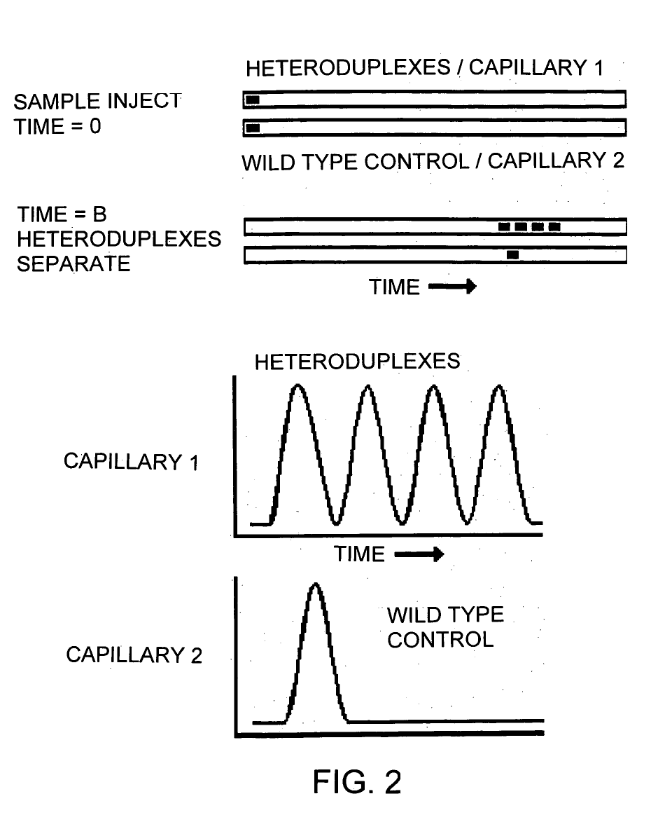

The sample may be subjected to electrophoresis along an electrophoresis lane, for example a capillary comprising a sieving matrix such as a gel matrix. The separation lane may comprise an intercalating dye. During electrophoresis, migrating sample components are subjected to a temperature gradient. Even though two homoduplexes have similar melting points and the two heteroduplexes have similar melting points, the melting points for the heteroduplexes are usually lower than those of the homoduplexes. Thus, if a positive temperature gradient is chosen, the Tm's of heteroduplexes will be reached first. The heteroduplexes will at least partially denature, thereby forming a bulky structure, which retards migration in along the separation lane. The overall result is that four DNA species will separated from each other (FIG. 2). When they pass through the detection window, the signal will be recorded by a CCD camera and showed as four distinct peaks. Compared to heterozygous samples, the wild-type control or homozygous samples will migrate as a single species.

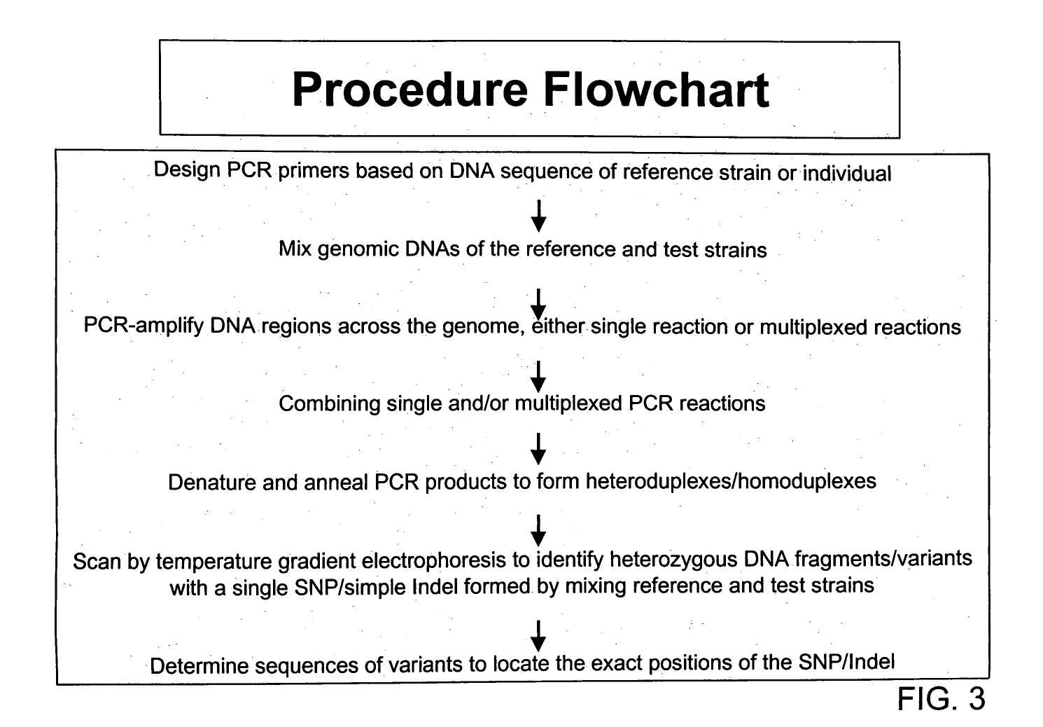

The method of the invention may include providing and/or designing PCR primers based on the DNA sequences of reference strains or individuals (FIG. 3). The primers may be prepared so that the whole genome or only a portion thereof will be amplified. Portions of the genome amplified by designed primers may overlap, for example by at least 2 bases, at least 5 bases, or at least 10 bases, to ensure that a potential variant site is within the priming sites of at least one primer. It should be understood that the flow chart of FIG. 3 is exemplary and that not every step is essential and that steps may be combined or changed in order in accordance with the present invention.

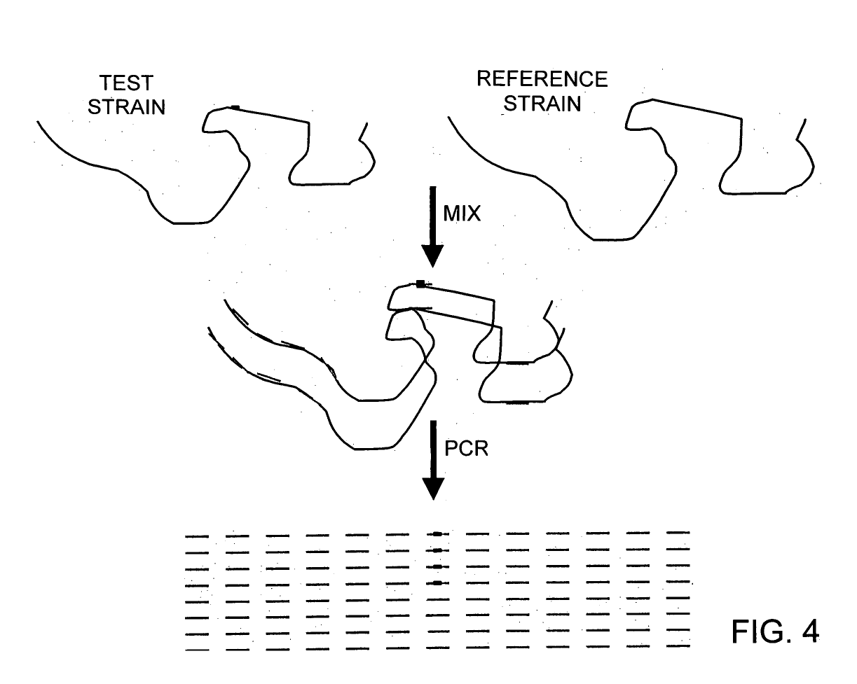

Genomic DNA from both a reference organism and a test (sample) organism may be extracted and mixed, preferably in a 1:1 ratio (FIG. 4). Amplification reactions, such as PCR reactions (either by a single or multiplexed reaction), may then be performed to amplify DNA regions corresponding to the primers. Where the reference and sample organisms include few variant sites, the majority of the PCR reactions will generate homozygous DNA products (amplicons), i.e., identical DNA sequences from both strains. A subset of the amplicons may comprise heterozygous DNA fragments, i.e., amplicons having a mismatch, for example, an insertion/deletion (indel) sequence present in amplicons from one of the two organisms.

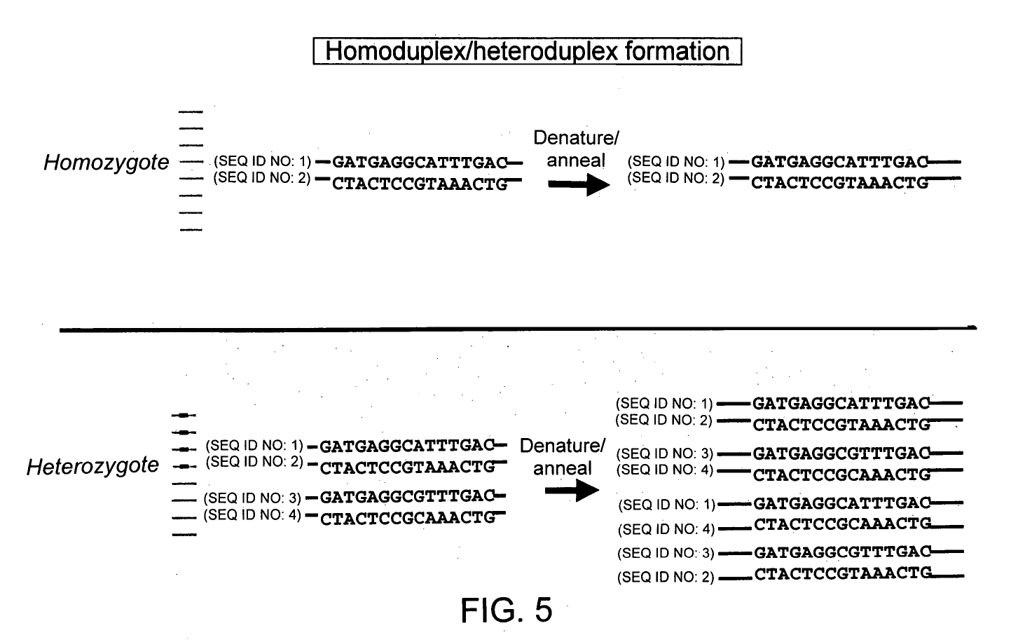

Amplicons, whether from single and/or multiplexed reactions, may be combined to prepare a mixture. The mixture may be subjected to at least one denaturing step and at least one annealing step to prepare duplexes. If the sequences of the sample and reference organisms do not comprise a difference, the duplexes will preferably not comprise heteroduplexes (FIG. 5). If the sequences of the sample and reference organisms comprise a difference, the duplexes will preferably comprise heteroduplexes (FIG. 5).

The duplexes may be subjected to TGE to obtain electrophoresis data indicative of the presence of a mismatch between a pair of amplicons. Electrophoresis data obtained from TGE of duplexes comprising only homozygous fragments, will exhibit only a single peak. In this case, no sequencing is required to determine the sequence of the sample amplicon (and thus the portion of the sample organism genomic DNA corresponding to the amplicon) because the electrophoresis data indicate that the sequences of the genomic DNA from the reference and sample organisms are the same.

Electrophoresis data obtained from TGE of duplexes comprising heterozygous fragments will exhibit a plurality of peaks and/or broadened peaks with respect to the homozygous fragments. Thus, the electrophoresis data may be used to identify amplicons of the sample organism which are different from amplicons of the reference organism genomic DNA, for example those amplicons indicative of a single point variation or simple indel between the two strains. It is understood that the amplicons are preferably indicative, for example identical with, the sequence of the DNA of the underlying organism.

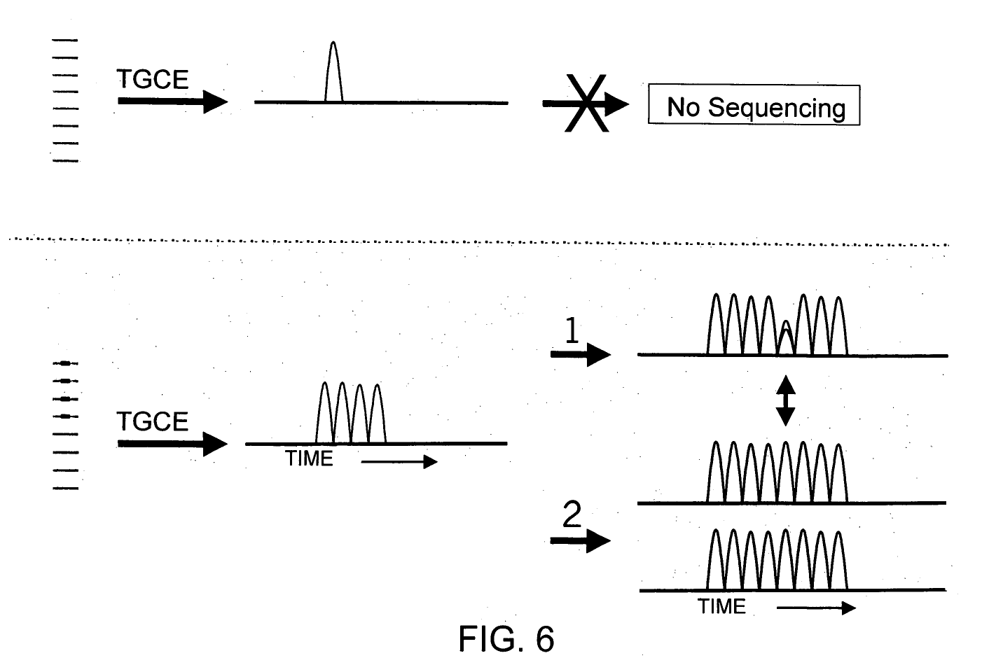

If an amplicon of the sample organism is found to be different from an amplicon of the reference organism, one or both of the amplicons may be sequenced. (FIG. 6). Alternatively, the portion of the genomic DNA of one or both of organisms may be sequenced either directly or from a different set of amplicons covering the suspected variant site. If a mixture of the reference and sample DNA (or a mixture of amplicons therefrom) is sequenced using electrophoresis, the mixed sample will generate two overlapped peaks for a mismatched site in the DNA molecule (top of FIG. 6), while separately sequencing the genomic DNA or amplicons therefrom will produce electrophoresis data having peaks indicative of a difference between the sequences. In any event, sequencing is preferably performed using multi-color fluorescence electrophoresis.

The method of the invention may also be used to analyze pooled samples (strains) and determine which PCR products amplified from pooled genomic DNAs generate electrophoresis data indicative of a difference between samples and reference polynucleotides corresponding to the samples. As discussed herein, electrophoresis data indicative of a variance between sample and reference polynucleotides may include peaks corresponding to heteroduplex/homoduplex peak patterns. If such patterns are detected, then genomic DNA and/or amplicons from samples corresponding to strains exhibiting such a difference may be sequenced and compared in order to locate the strain that contains the site of the variation.

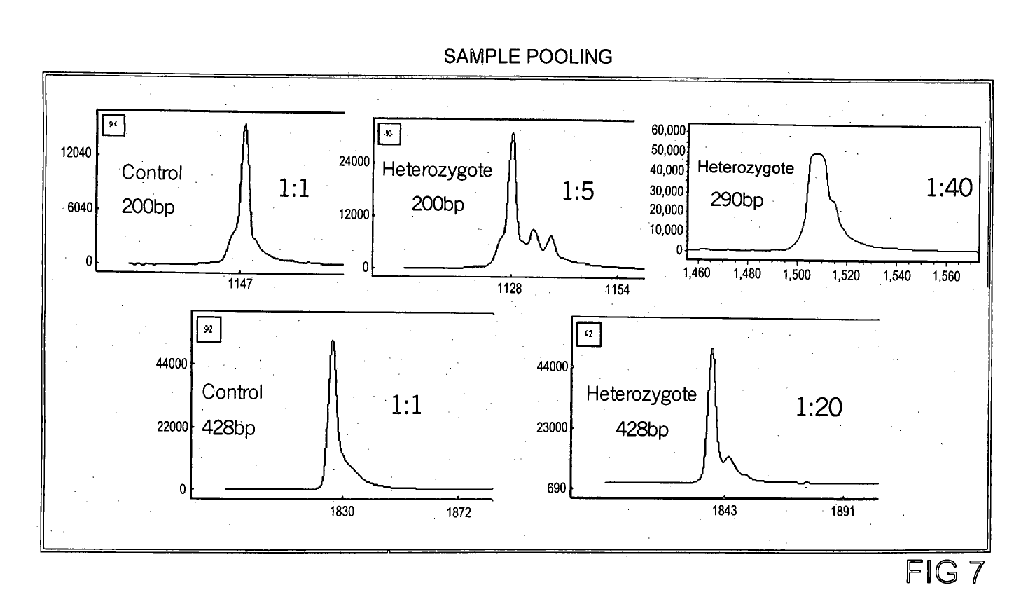

Referring to FIG. 7, DNA samples of different sizes were combined in different ratios. Each sample comprises at least one homozygous wild-type control and a mutation homozygote with a single point polymorphism. The mixtures were subjected to temperature gradient electrophoresis to obtain electrophoresis data, which, in this example, comprise fluorescence intensity v time data. The electrophoresis data of FIG. 7 demonstrate that a sample comprising a ratio of 1 amplicon with a single point mutation/SNP to 40 amplicons without such a mutation can be distinguished from control mixtures. Preferably, amplicons of at least 5, at least 10, at least 20, or at least 40 strains and or organisms (such as different humans) may be pooled and subjected to simultaneous TGE along a single electrophoresis lane. Of course, multiple such electrophoresis lanes may be used.

Referring to FIGS. 1-7, an embodiment of the invention relates to a method of determining whether a sequence of a first portion of a polynucleotide of a first organism and a sequence of a first portion of a polynucleotide of a second organism comprise a mismatch, for example, a sequence difference between the two organisms. The method may include preparing a plurality of duplexes, at least some of the duplexes may comprise (i) a first polynucleotide strand having a sequence corresponding to a sequence of a first portion of genomic DNA of a first organism and (ii) a first complementary polynucleotide strand having a sequence corresponding to a sequence of a first portion of genomic DNA of a second organism. FIG. 1 illustrates how duplexes may be prepared from two polynucleotides, each preferably a duplex. The control polynucleotide may be a reference polynucleotide comprising genomic DNA of a reference organism. The polynucleotide to be compared with the control polynucleotide may be genomic DNA, such as of another organism. The present invention allows one to determine whether the polynucleotide to be compared with the control and the control polynucleotide comprise a difference. The sequence of the reference organism polynucleotide need not be known to determine whether the reference DNA and the control DNA comprise a difference. The sequence of the reference organism may be known and allow determine of a sequence of the sample organism. For example, the sequence of at least a portion of the reference organism (or amplicon obtained therefrom) may be known. The method may comprise determining a sequence of at least a portion of a polynucleotide (such as genomic DNA) of a sample organism based on electrophoresis data and the known sequence of the reference organism.

The duplexes may be subjected to temperature gradient electrophoresis as illustrated in FIG. 2 to obtain first electrophoresis data indicative of the presence of a mismatch between (a) the sequence of the first portion of the genomic DNA of the first organism and (b) the sequence of the complementary portion of the genomic DNA of the second organism.

The present method provides a highly effective means for comparative genome sequencing, is rapid and cost-efficient. The technique may be used to quickly and inexpensively generate bioinformatively variable sites by scanning part of the genome for the purpose of establishing a database. For example, in the case of a bioterror attack or disease outbreak, one can use the informative DNA data to quickly identify what virulent strains were present, the source of the strains, and other relevant information. An aspect of the present invention relates to a system and method for performing comparative sequencing, such as high throughput comparative screening. The method is rapid, cost efficient and suitable for increasing the amount of information present in DNA databases used in, for example, biodefense and disease monitoring.

Comparative sequencing may be used to determine at least a portion or essentially all of the genomic sequences of preferably closely related species/races/strains. For example, the sequence of the individual Craig Venter's is now known. The present invention is suitable for rapidly determining the sequence of an individual, for example, a related individual such as Venter's brother. Because the two individuals are brothers, they will have a high genetic similarity. It is very difficult for known methods of DNA fingerprinting to determine differences between such similar genetic sequences.

A second example can be used to illustrate the advantages of the present invention. A recent publication (discussed above) described the comparative sequencing (using known sequencing techniques) of three Anthrax strains. The authors of this study sequenced each strain eight times at a rough cost of $676,000/genome. Multiple screenings were required to eliminate sequencing errors. Only four sites of differences were found between the three Anthrax strains, each having about 5.2 MBp. The present invention allows for rapid, inexpensive comparative screening of related strains of DNA such as the Anthrax strains described above. In accordance with a preferred embodiment, a reference and a test strain may be combined to form a mixture. PCR primers preferably obtained from the reference strain are added to the mixture. Polymerase chain reaction may be used to amplify the DNA of the reference and test strains. Temperature gradient electrophoresis is performed on the resulting PCR products.

Returning to the example of the Anthrax strains, four sites of differences were observed via the comparative screening performed by known techniques. According to the present invention, only four amplicons obtained from the PCR amplification would contain heteroduplexes, which would be caused by differences between the different Anthrax strains. Only these amplicons would produce TGE peak patterns indicative of a difference between the reference and test strain DNA. Thus, when comparing the DNA from one organism to another, the present invention allows the determination of those subsets of the DNA that contain differences.

These amplicons indicative of differences between the organism may be sequenced either from pooled DNA or from individual DNAs. In this example, therefore, the present invention reduces the problem of sequencing the entire genome of an organism to the sequencing of 4 fragments. Because the TGE data complements the direct sequencing data, the fragments do not have to be sequenced 8 times to obtain reliable sequencing data.

The present invention also reduces the cost of determining the sequence of a related organism. The present TGE method does not require a cloning step, just PCR reactions. Staying with the Anthrax example, only about 10,000 amplicons of about 400-500 bp each are required to perform TGE on PCR products obtained from the entire 5.2 mbp Anthrax genome. Assuming that only 1 amplicon is run per separation lane, TGE of these amplicons may be accomplished using about 100 96-well trays. If each amplicon is subjected to two TGE runs, and 12 runs/day are performed, the entire Anthrax genome can be sequenced in 20 days. According to the invention, more than one amplicon can be run simultaneously per separation lane. For example, if three amplicons/capillary are multiplexed, only one week is required to sequence the Anthrax genome.

The method of the invention may be used to rapidly generate informative SNPs by scanning all or part of the genome. In the case of, for example, bioterror attacks or disease outbreak, one can use these informative SNPs to quickly find out what virulent strains they are and the source of the strains. Thus, the present invention provides a method for identifying an organism and in particular the strain of an organism such as, for example, pathogens including viruses and bacteria.

While the above invention has been described with reference to certain preferred embodiments, it should be kept in mind that the scope of the present invention is not limited to these. Thus, one skilled in the art may find variations of these preferred embodiments which, nevertheless, fall within the spirit of the present invention, whose scope is defined by the claims set forth below.

What is claimed is:

1. A method of determining whether a sequence of a first portion of a polynucleotide of a first organism and a sequence of a first portion of a polynucleotide of a second organism comprise a mismatch, the method comprising:
preparing a plurality of duplexes, the duplexes comprising:
(i) a first polynucleotide strand having a sequence corresponding to a sequence of a first portion of genomic DNA of a first organism; and
(ii) a first complementary polynucleotide strand having a sequence corresponding to a sequence of a first portion of genomic DNA of a second organism;
subjecting the duplexes to temperature gradient electrophoresis to obtain first electrophoresis data indicative of the presence of a mismatch between (a) the sequence of the first portion of the genomic DNA of the first organism and (b) the sequence of the complementary portion of the genomic DNA of the second organism.

2. The method of claim 1, comprising:
preparing a plurality of different duplexes, the duplexes comprising:
(i) a first polynucleotide strand having a sequence corresponding to a sequence of one of a plurality of different portions of the genomic DNA of the first organism; and
(ii) a first complementary polynucleotide strand having a sequence corresponding to a sequence of one of a plurality of different portions the genomic DNA of the second organism;
subjecting the plurality of different duplexes to temperature gradient electrophoresis to obtain, for each of the different duplexes, first electrophoresis data indicative of the presence of a mismatch between (a) the sequence of the first portion of the genomic DNA of the first organism and (b) the sequence of the complementary portion of the genomic DNA of the second organism.

3. A method of determining whether a sequence of a first portion of a polynucleotide of a first organism and a sequence of a first portion of a polynucleotide of a second organism comprise a difference, the method comprising:
amplifying at least a first portion of a polynucleotide of a first organism to prepare amplicons of the first organism, the amplicons of the first organism corresponding to a sequence of the polynucleotide of the first portion of the first organism;
amplifying at least a first portion of a polynucleotide of a second organism to prepare amplicons of the second organism, the amplicons of the second organism corresponding to a sequence of the polynucleotide of the first portion of the second organism;
preparing a plurality of duplexes, at least some of the duplexes comprising amplicons of the first organism and amplicons of the second organism;
subjecting the duplexes to temperature gradient electrophoresis to obtain first electrophoresis data indicative of the presence of a difference between (a) a sequence of the first portion of the polynucleotide of the first organism and (b) a sequence of the first portion of the polynucleotide of the second organism.

4. The method of claim 3, comprising determining the presence of a difference between the sequence of the first portion of the polynucleotide of the first organism and the sequence of the first portion of the polynucleotide of the second organism based on the electrophoresis data.

5. The method of claim 4, wherein the sequence of the first amplicon of the second organism is known and the method comprises determining a sequence of the first portion of the polynucleotide of the first organism based on the electrophoresis data and the known sequence of the first amplicon of the second organism.

6. The method of claim 3, wherein the first organism is a first mammal.

7. The method of claim 6, wherein the first organism is a human.

8. The method of claim 7, wherein the second organism is a second, different mammal.

9. The method of claim 8, wherein the second organism is a second, different human.

10. The method of claim 10, wherein the polynucleotide of the first organism comprises genomic DNA of the first organism.

11. The method of claim 10, wherein the polynucleotide of the second organism comprises genomic DNA of the second organism.

12. The method of claim 11, wherein the first amplicons of the first organism and the first amplicons of the second organism are prepared concomitantly.

13. The method of claim 12, wherein the first amplicons of the first organism and the first amplicons of the second organism are prepared by a multiplexed amplification reaction.

14. The method of claim 11, wherein the method further comprises:
amplifying at least a second portion of the polynucleotide of the first organism to prepare second amplicons of the first organism, the second amplicons of the first organism corresponding to a sequence of the second portion of the polynucleotide of the first organism;
amplifying at least a second portion of the polynucleotide of the second organism to prepare second amplicons of the second organism, the second amplicons of the second organism corresponding to a sequence of the second portion of the polynucleotide of the second organism;
preparing a plurality of second duplexes, at least some of the duplexes comprising second amplicons of the first organism and second amplicons of the second organism;
subjecting the second duplexes to temperature gradient electrophoresis to obtain first electrophoresis data indicative of the presence of a difference between (a) a sequence of the second portion of the polynucleotide of the first organism and (b) a sequence of the second portion of the polynucleotide of the second organism.

15. A method of determining whether a sequence of a first portion of a polynucleotide of a first organism and a sequence of a first portion of a polynucleotide of a second organism comprise a difference, the method comprising:
amplifying at least a first portion of a polynucleotide of a first organism to prepare first amplicons of the first organism;
amplifying at least a first portion of a polynucleotide of a second organism to prepare first amplicons of the second organism;
denaturing the first amplicons of the first organism;
denaturing the first amplicons of the second organism;
subjecting a mixture comprising the respective denatured first amplicons of the first and second organisms to annealing; and
subjecting the respective first amplicons of the first and second organisms to temperature gradient electrophoresis to obtain first electrophoresis data indicative of the presence of a difference between (a) a sequence of the first portion of the polynucleotide of the first organism and (b) a sequence of the first portion of the polynucleotide of the second organism.

16. The method of claim 15, comprising determining the presence of a difference between the sequence of the first portion of the polynucleotide of the first organism and the sequence of the first portion of the polynucleotide of the second organism based on the electrophoresis data.

17. The method of claim 16, wherein the sequence of the first amplicon of the second organism is known and the method comprises determining a sequence of the first portion of the polynucleotide of the first organism based on the electrophoresis data and the known sequence of the first amplicon of the second organism.

18. The method of claim 15, wherein the first organism is a first mammal.

19. The method of claim 18, wherein the first organism is a human.

20. The method of claim 19, wherein the second organism is a second, different mammal.

21. The method of claim 20, wherein the second organism is a second, different human.

22. The method of claim 21, wherein the polynucleotide of the first organism comprises genomic DNA of the first organism.

23. The method of claim 22, wherein the polynucleotide of the second organism comprises genomic DNA of the second organism.

24. The method of claim 23, wherein the first amplicons of the first organism and the first amplicons of the second organism are prepared concomitantly.

25. The method of claim 24, wherein the first amplicons of the first organism and the first amplicons of the second organism are prepared by a multiplexed amplification reaction.

26. The method of claim 23, wherein the method further comprises:
amplifying at least a second portion of the polynucleotide of the first organism to prepare second amplicons of the first organism;
amplifying at least a second portion of the polynucleotide of the second organism to prepare second amplicons of the second organism;
denaturing the second amplicons of the first organism;
denaturing the second amplicons of the second organism;
subjecting a mixture comprising the respective denatured second amplicons of the first and second organisms to annealing.

27. The method of claim 26, wherein the mixture comprising the respective denatured first amplicons of the first and second organisms and the mixture comprising the respective denatured second amplicons of the first and second organisms are the same mixture.

28. The method of claim 26, wherein the step of subjecting the respective first amplicons of the first and second organisms to temperature gradient electrophoresis comprises subjecting the respective second amplicons of the first and second organisms to temperature gradient electrophoresis to obtain second electrophoresis data indicative of the presence of a difference between a sequence of the second portion of the polynucleotide of the first organism and a sequence of the second portion of the polynucleotide of the second organism.

29. The method of claim 28, comprising determining the presence of a difference between the sequence of the second portion of the polynucleotide of the first organism and the sequence of the second portion of the polynucleotide of the second organism based on the electrophoresis data.

30. The method of claim 28, wherein the first and second amplicons of the first and second organisms are prepared concomitantly.

31. The method of claim 30, wherein the first and second amplicons of the first and second organisms are prepared by a multiplexed amplification reaction.

32. The method of claim 28, wherein the step of subjecting comprises jointly subjecting the first and second amplicons of the first and second organisms to temperature gradient electrophoresis along a common electrophoresis lane.

33. The method of claim 32, wherein the first amplicons of the first and second organisms and the second amplicons of the first and second organisms exhibit different electrophoretic migration velocities, the electrophoretic migration velocities of the first and second amplicons differing by an amount sufficient to determine the presence of one of the first and second amplicons in the presence of the other of the first and second amplicons even in the absence of (a) a difference between the sequence of the first portion of the polynucleotide of the first organism and the sequence of the first portion of the polynucleotide of the second organism and (b) a difference between the sequence of the second portion of the polynucleotide of the second organism and the sequence of the second portion of the polynucleotide of the second organism.

34. The method of claim 32, wherein the first and second amplicons each comprise a length of at least 50 bp.

35. The method of claim 34, wherein the first and second amplicons each comprise a length of at least 150 bp.

36. The method of claim 34, wherein the first and second amplicons have different lengths.

37. The method of claim 32, wherein the electrophoresis lane is a capillary.

38. The method of claim 26, wherein the method further comprises:
amplifying at least a third portion of the polynucleotide of the first organism to prepare third amplicons of the first organism;
amplifying at least a third portion of the polynucleotide of the second organism to prepare third amplicons of the second organism;
denaturing the third amplicons of the first organism;
denaturing the third amplicons of the second organism;
subjecting a mixture comprising the respective denatured third amplicons of the first and second organisms to annealing.

39. The method of claim 38, wherein the mixture comprising the respective denatured first amplicons of the first and second organisms, the mixture comprising the respective denatured second amplicons of the first and second organisms are the same mixture, and the mixture comprising the respective denatured third amplicons of the first and second organisms are the same mixture.

40. The method of claim 38, wherein the first, second, and third amplicons of the first and second organisms are prepared concomitantly.

41. The method of claim 40, wherein the first, second, and third amplicons of the first and second organisms are prepared by a multiplexed amplification reaction.

42. The method of claim 38, wherein the step of subjecting the respective first amplicons of the first and second organisms to temperature gradient electrophoresis comprises subjecting the second and third amplicons of the first and second organisms to temperature gradient electrophoresis to obtain (a) second electrophoresis data indicative of the presence of a difference between a sequence of the second portion of the polynucleotide of the first organism and a sequence of the second portion of the polynucleotide of the second organism and (b) third electrophoresis data indicative of the presence of a difference between a sequence of the third portion of the polynucleotide of the first organism and a sequence of the third portion of the polynucleotide of the second organism.

43. The method of claim 42, wherein the step of subjecting comprises jointly subjecting the first, second, and third amplicons to temperature gradient electrophoresis along a common electrophoresis lane.

44. The method of claim 43, wherein the electrophoresis lane is a capillary.

45. The method of claim 29, comprising determining the presence of a difference between a sequence of the first portion of the polynucleotide of the first organism and a sequence of the first portion of the polynucleotide of the second organism based on the electrophoresis data.

46. The method of claim 15, wherein (i) the step of subjecting the respective first amplicons of the first and second organisms to temperature gradient electrophoresis comprises (a) amplicon injection, wherein at least the first amplicons are introduced to a separation lane, and (b) electrophoresis, wherein at least the first amplicons migrate along the separation lane and, (ii) wherein the step of subjecting a mixture comprising the respective denatured first amplicons of the first and second organisms to annealing is performed prior to electrophoresis.

47. A method of determining a sequence of a portion of a polynucleotide of a first organism, comprising:
amplifying: (a) a plurality of sub-portions of a polynucleotide of a first organism to prepare amplicons corresponding to the sub-portions of the polynucleotide of the first organism and (b) a plurality of sub-portions of a polynucleotide of a second organism to prepare amplicons corresponding to the sub-portions of the polynucleotide of the second organism, the sub-portions of the second organism each having a known sequence;
forming a plurality of duplexes comprising an amplicon of the first organism and an at least partially complementary amplicon of the second organism;
subjecting the duplexes to temperature gradient electrophoresis to obtain, for respective duplexes, electrophoresis data indicative of the presence of a mismatch between the amplicon of the first organism and the at least partially complementary amplicon of the second organism;
determining duplexes having a mismatch;
for duplexes determined to have a mismatch, determining the identity of the mismatch between the amplicon of the first organism and the at least partially complementary amplicon of the second organism based on the known sequences of the corresponding sub-portion of the second organism; and
determining the sequence of at least a portion of the polynucleotide of the first organism based on (a) the known sequences of sub-portions of the second organism determined from the electrophoresis data not to have a mismatch with sub-portions of the first organism and (b) the identity of mismatches between amplicons of the first and second organisms.

48. A method of determining whether a sequence of a first portion of a polynucleotide of a first organism and a sequence of a first portion of a polynucleotide of a second organism comprise a difference, the method comprising:
amplifying at least a first portion of a polynucleotide of a first organism to prepare first amplicons of the first organism;
amplifying at least a first portion of a polynucleotide of a second organism to prepare first amplicons of the second organism;
denaturing the first amplicons of the first organism;
denaturing the first amplicons of the second organism;
subjecting a mixture comprising the respective denatured first amplicons of the first and second organisms to annealing; and
subjecting the respective first amplicons of the first and second organisms to temperature gradient electrophoresis to obtain first electrophoresis data indicative of the presence of a difference between (a) a sequence of the first portion of the polynucleotide of the first organism and (b) a sequence of the first portion of the polynucleotide of the second organism.

49. A method of determining whether a sequence of a first portion of a polynucleotide of a first organism and a sequence of a first portion of a polynucleotide of a second organism comprise a difference, the method comprising:
combining a polynucleotide of a first organism and a polynucleotide of a second organism, the polynucleotide of the first organism comprising a first portion and the polynucleotide of the second organism comprising a first portion;
amplifying at least the first portion of the polynucleotide of the first organism and the first portion of the polynucleotide of the second organism to prepare first amplicons comprising the amplified first portions;
denaturing the first amplicons;
annealing the first amplicons; and
subjecting the first amplicons to temperature gradient electrophoresis to obtain first electrophoresis data indicative of the presence of a difference between a sequence of the first portion of the polynucleotide of the first organism and a sequence of the first portion of the polynucleotide of the second organism.

50. The method of claim 49, wherein the first organism is a first mammal.

51. The method of claim 50 wherein the first organism is a human.

52. The method of claim 51, wherein the second organism is a second, different mammal.

53. The method of claim 52, wherein the second organism is a second, different human.

54. The method of claim 53, wherein the polynucleotide of the first organism comprises genomic DNA of the first organism.

55. The method of claim 54, wherein the polynucleotide of the second organism comprises genomic DNA of the second organism.

56. A method of determining a sequence of at least a portion of a genome of a first organism, comprising:
providing reference DNA obtained from a genome of a reference organism;
providing PCR primers suitable for amplifying the reference DNA;
using the PCR primers to amplify the reference DNA in the presence of the portion of the genome of the first organism to thereby obtain amplicons;
subjecting the amplicons to temperature gradient electrophoresis (TGE) to obtain electrophoresis data;
identifying at least one amplicon indicative of a variance between the reference DNA and the portion of the genome of the first organism based on the electrophoresis data;
sequencing the at least one amplicon indicative of a variance to determine the sequence of the portion of the genome of the first organism.
